(19) United States
(12) Patent Application Publication
(10) Pub. No.: US 2015/0117804 A1
(43) Pub. Date: Apr. 30, 2015

(54) GAS TURBINE ENGINE BUSHING

(71) Applicant: United Technologies Corporation, Hartford, CT (US)

(72) Inventor: Andrew G. Alarcon, Farmington, CT (US)

(21) Appl. No.: 14/522,885

(22) Filed: Oct. 24, 2014

Related U.S. Application Data
(60) Provisional application No. 61/897,394, filed on Oct. 30, 2013.

(51) Int. Cl. F01D 25/16; F16C 33/08; F16C 17/02

(52) U.S. Cl. CPC F01D 25/166; F01D 25/162; F16C 17/02; F16C 33/08; F05D 2220/36; F05D 2230/60; F05D 2240/52; F05D 2240/80
USPC 384/296; 29/888.02

(57) ABSTRACT

A gas turbine engine bushing includes a flange area, and an insert area to be received within an aperture. The insert area includes channels and a bond rib. The channels extend axially a channel distance. The bond rib extends axially a bond rib distance. The channel distance is eater than the bond rib distance.

### CROSS-REFERENCE TO RELATED APPLICATION

This application claims priority to U.S. Provisional Application No. 61/897394 filed on Oct. 20, 2013.

### BACKGROUND

This disclosure relates generally to a bushing and, more particularly, to adhesive holding channels in a radially outer wall of a gas turbine bushing.

A gas turbine engine typically includes a compressor section, a combustor section, and a turbine section. Air entering the compressor section is compressed and delivered into the combustor section where it is mixed with fuel and ignited to generate a high-speed exhaust gas flow. The high-speed exhaust gas flow expands through the turbine section to drive the compressor.

The compressor section typically includes low and high pressure compressors, and the turbine section typically includes low and high pressure turbines. Typically, one of the turbines is a power turbine and drives a fan section or helicopter rotor. The power turbine may additional drive a compressor.

In some gas turbine engines, a speed reduction device, such as an epicyclical gear assembly, is utilized to drive the fan section such that the fan section may rotate at a speed different from, and typically slower than, the turbine section to increase the overall propulsive efficiency of the engine. In such engine architectures, a shaft driven by the power turbine provides an input to the epicyclical gear assembly that drives the fan section at a reduced speed so that both the power turbine and the fan section can rotate at closer to optimal speeds.

Bushings are used in various locations within the gas turbine engines. A fan blade platform, for example, may receive a bushing. A pin is held within the bushing. The pin is rotatable relative to the fan blade platform and the bushing. The bushing prevents the fan blade platform from wearing due to rotation of the pin.

### SUMMARY

A bushing according to an exemplary aspect of the present disclosure includes, among other things, a flange area and an insert area to be received within an aperture. The insert area includes channels and a bond rib. The channels extend axially a channel distance. The bond rib extends axially a bond rib distance. The channel is distance greater than the bond rib distance.

In a further non-limiting embodiment of the foregoing bushing, the channels are at least partially provided by a cylindrical bottom.

In a further non-limiting embodiment of any of the foregoing bushings, the flange area and the insert area are disposed along an axis, and the cylindrical bottom is parallel to the axis.

In a further non-limiting embodiment of any of the foregoing bushings, the channels are at least partially provided by transitions that are angled relative to the cylindrical bottom.

In a further non-limiting embodiment of any of the foregoing bushings, the transitions are frustoconical.

In a further non-limiting embodiment of any of the foregoing bushings, the bond rib comprises a single bond rib extending circumferentially about the insert area of the bushing.

In a further non-limiting embodiment of any of the foregoing bushings, the channels comprise a first channel and a second channel. The bond rib is positioned axially between the first channel and the second channel.

In a further non-limiting embodiment of any of the foregoing bushings, the bond rib extends helically about the insert portion.

In a further non-limiting embodiment of any of the foregoing bushings, the bushing includes an aperture to receive a pin.

In a further non-limiting embodiment of any of the foregoing bushings, a gas turbine engine component provides the aperture.

A gas turbine engine assembly according to another exemplary aspect of the present disclosure includes, among other things, a gas turbine engine component providing an aperture, and a bushing adhesively secured within the aperture. The bushing includes channels and a bond rib. The channels extend axially a channel distance. The bond rib extends axially a bond rib distance. The channel distance is greater than the bond rib distance.

In a further non-limiting embodiment of the foregoing gas turbine engine assembly, the channels are at least partially provided by a cylindrical bottom.

A method of installing a bushing into an aperture of a gas turbine engine component, according to yet another exemplary aspect of the present disclosure includes, among other things, applying adhesive to channels of a bushing, inserting the bushing into an aperture, and limiting movement of adhesive from the channels using a bond rib. The channels extend axially a channel distance and the bond rib extends axially a bond rib distance that is less than the channel distance.

In a further non-limiting embodiment of the foregoing method, the channels may have cylindrcial bottoms.

In a further non-limiting embodiment of any of the foregoing methods, the bond rib contacts a gas turbine engine component during insertion to limit movement of adhesive.

### DESCRIPTION OF THE FIGURES

The various features and advantages of the disclosed examples will become apparent to those skilled in the art from the detailed description. The figures that accompany the detailed description can be briefly described as follows:

FIG. 1 shows a cross-section view of an example gas turbine engine.

FIG. 2 shows a cross-section view of a portion of the gas turbine engine of FIG. 1 incorporating a bushing.

FIG. 3 shows a cross-section view of the bushing of FIG. 2.

### DETAILED DESCRIPTION

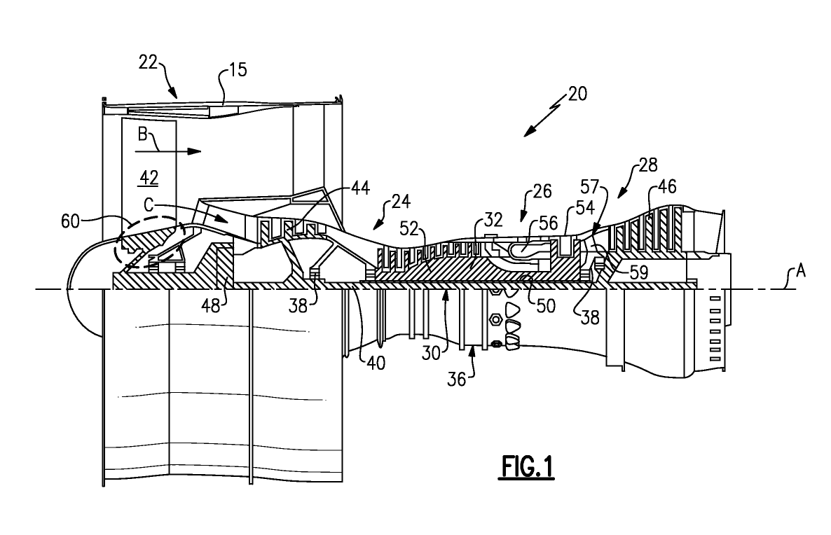

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]° ^{0.5}The “Low corrected fan tip speed” as disclosed herein according to one non-limiting embodiment is less than about 1150 ft/second.

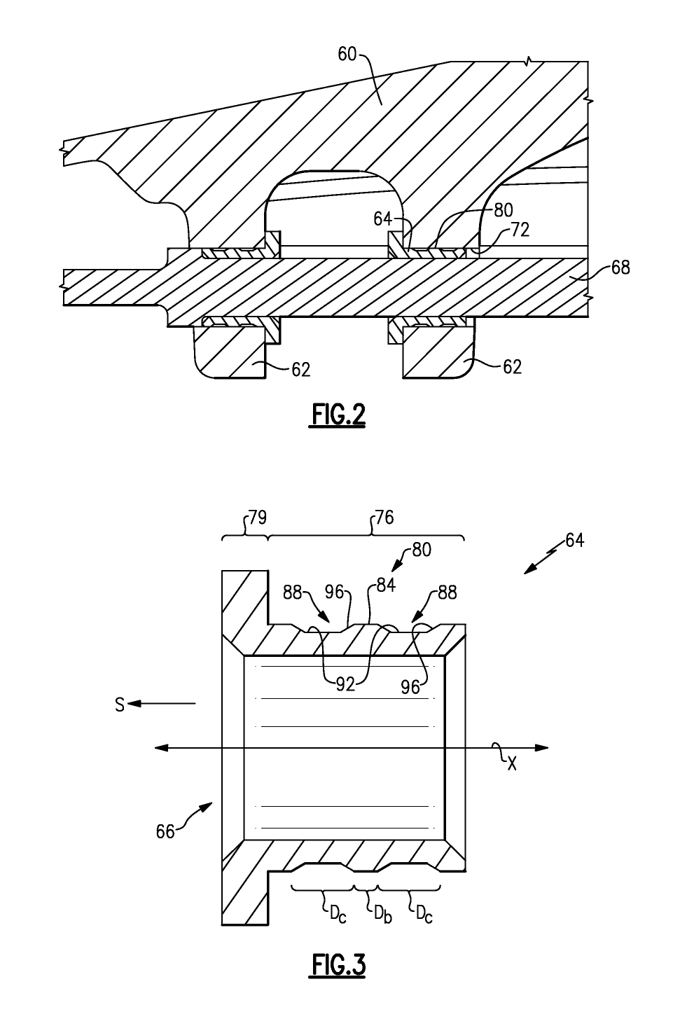

Referring now to FIGS. 2 and 3, the fan 42 includes a plurality of fan blade platforms 60 having radially extending flanges 62. Blades of the fan 42 abut the fan blade platforms 60. A bushing 64 is received within apertures in the flanges 62. The bushings 64 each include an aperture 66 to receive a pin 68 to retain the fan blade platform 60 to a fan rotor of the engine 20.

The fan blade platforms 60 are an example type of gas turbine engine component that provides an aperture for receiving a bushing 64. Other gas turbine components provide apertures that receive bushings. A person having skill in this art and the benefit of this disclosure will understand that the bushing 64 could be used in various areas of the gas turbine engine 20.

In this example, the fan blade platform 60 and the bushing 64 are made of different materials. Specifically, in this example, the fan blade platform 60 is a composite material, and the bushing 64 is a metallic material. The pin 68 is rotatable within the bushing 64. The pin 68, in this example, is metallic. The bushing 64, among other things, prevents the pin 68 from wearing the fan blade platform 60, when rotating.

The bushing 64 is adhesively secured within an aperture 72 of the fan blade platform 60. The bushing 64 includes a flange area 74 and an insert area 76 extending along an axis X. The insert area 76 is received within the aperture 72. The flange area 74 contacts the fan blade platform 60 to limit axial movement of the bushing 64 into the aperture 72

A radially outward facing wall 80 of the bushing 64 interfaces with the platform 60 when the insert area 76 is received within the aperture 72. The wall 80 includes a bond rib 84 extends radially outward. The bond rib 84 is axially between channels 88 and 88′ in the radially outward facing wall 80.

During assembly of the bushing 64 to the blade platform 60, adhesive, such as an epoxy adhesive, is inserted into the channels 88 and 88′. The bushing 64 is then moved axially into the aperture 72. A diameter of the bond rib 84 is very close to a diameter of the aperture 72. In some examples, the bond rib 84 can rub against the blade platform 60 when the insert area 76 is moved into the aperture 72. The bond rib 84 limits adhesive movement out of at least the channel 88, the channels 88′, or both during insertion of the bushing 64 into the aperture 72.

Maintaining adhesive within the channels 88 and 88′ facilitates a relatively strong bond line between the radially outward facing wall 80 and the blade platform 60. In the prior art, significant adhesive squished out of the channels during insertion weakening bond lines with bushings. Maintaining a relatively strong bond line helps maintain the bushing 64 within the aperture 72 when loads are applied, especially sheer loads in a direction S along the axis X.

The example channels 88 and 88′, in the example section view, include flat or planar bottoms 92 and angled transitions 96 to the axial ends of the insert area 76 and the bond rib 84. The channels 88 and 88′ are thus not “V” shaped.

The bottoms 92 are parallel to the axis X in this example. As the bottoms 92 extend circumferentially about the axis X, the example, bottoms 92 are generally cylindrical.

The angled transitions 96 extend at about a forty-five degree angle relative to the bottoms 92 in this example. The transitions 96 are planar in the section view of this example. In other examples, the transitions 96 are curved. As the transitions 96 extend circumferentially about the axis X, the transitions are generally frustoconical.

The bushing 64 may be turned or knurled to create the channels 88 and 88′. A person having skill in this art and the benefit of this disclosure may be able to develop other methods of creating the channels 88 and 88′ in the bushing 64.

The channels 88 and 88′ extend along the outwardly facing wall 80 for a distance D_{c}. The channels 88 and 88′ are filled with adhesive, such as an epoxy adhesive, prior to insertion of the bushing 64 into the aperture 72. The transitions 96 are considered to form a portion of the channels 88 and 88′ because the transitions 96 are covered with adhesive.

The bond rib 84 extends along the outwardly facing wall 80 for a distance Dᵣ. The total distance D_{c} of the channels 88 and 88′ is greater than a total distance D_{b} of the bond rib 84.

The example bond rib 84 comprises a single bond rib that extends about an entire circumference of the bushing 64 and is a complete ring. In other examples, the bond rib 84 extends partially about the bushing 64. The bond rib 84 may be helical.

Although only one bond rib 84 is used in this example, other examples may include multiple bond ribs. For example, if the insert area 76 includes three channels, two bond ribs can be used. One of the two bond ribs would be positioned between two of the three channels.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

I claim:

1. A bushing comprising:
a flange area; and
an insert area to be received within an aperture, the insert area including channels and a bond rib, the channels extending axially a channel distance, the bond rib extending axially a bond rib distance, the channel distance greater than the bond rib distance.

2. The bushing of claim 1, wherein the channels are at least partially provided by a cylindrical bottom.

3. The bushing of claim 2, wherein the flange area and the insert area are disposed along an axis, and the cylindrical bottom is parallel to the axis.

4. The bushing of claim 2, wherein the channels are at least partially provided by transitions that are angled relative to the cylindrical bottom.

5. The bushing of claim 4, wherein the transitions are frustoconical.

6. The bushing of claim 1, wherein the bond rib comprises a single bond rib extending circumferentially about the insert area of the bushing.

7. The bushing of claim 1, wherein the channels comprise a first channel and a second channel, the bond rib positioned axially between the first channel and the second channel.

8. The bushing of claim 1, wherein the bond rib extends helically about the insert portion.

9. The bushing of claim 1, wherein the bushing includes an aperture to receive a pin.

10. The bushing of claim 1, wherein a gas turbine engine component provides the aperture.

11. A gas turbine engine assembly, comprising:
a gas turbine engine component providing an aperture; and
a bushing adhesively secured within the aperture, the bushing including channels and a bond rib, the channels extending axially a channel distance, the bond rib extending axially a bond rib distance, the channel distance greater than the bond rib distance.

12. The assembly of claim 11, wherein the channels are at least partially provided by a cylindrical bottom.

13. A method of installing a bushing into an aperture of a gas turbine engine component, comprising:
applying adhesive to channels of a bushing;
inserting the bushing into an aperture; and
limiting movement of adhesive from the channels using a bond rib, wherein the channels extend axially a channel distance and the bond rib extends axially a bond rib distance that is less than the channel distance.

14. The method of claim 13, wherein the channels have cylindrical bottoms.

15. The method of claim 13, wherein the bond rib contacts a gas turbine engine component during the inserting to limit movement of adhesive.
